(19) United States
(12) Patent Application Publication
(10) Pub. No.: US 2008/0234847 A1
(43) Pub. Date: Sep. 25, 2008

(54) Glasses-type media player

(76) Inventor: Hsuan-Lang Lin, Taipei City (TW)

Correspondence Address: TROXELL LAW OFFICE PLLC, Suite 1404, 5205 Leesburg Pike, Falls Church, VA, 22041, US

(21) Appl. No.: 11/723,401

(22) Filed: Mar. 19, 2007

(51) Int. Cl. G06F 17/00

(52) U.S. Cl. 700/94

(57) ABSTRACT

A glasses-type media player is utilized for reading information stored in an external memory card. The glasses-type media player comprises a wearing body, a circuit control unit, a video/audio output unit and a power source. The wearing body is coupled to the circuit control unit, the video/audio output unit and the power source. The circuit control unit comprises a video/audio processing circuit, a control interface and at least one memory card slot. The video/audio processing circuit is electrically connected to the memory card slot and the control interface. The video/audio output unit comprises a microdisplay device and an audio output device, which are electrically connected to the video/audio processing circuit. By the use of such structure, the present invention has the advantages of large screen, low power consumption, high privacy, long operable time, easy use, and convenient carriage.

### FIELD OF THE INVENTION

The present invention relates to a glasses-type media player, and more particularly to a glasses-type media player that has a wearing body coupled to a circuit control unit, a video/audio output unit and a power source to provide the advantages of large screen, low power consumption, high privacy, long operable time, easy use and convenient carriage.

### BACKGROUND OF THE INVENTION

Because the global selling result of the MP3 music player is very good, the higher level portable media player (abbreviated as PMP) is gradually disclosed by many manufacturers. The portable media player can display the current MP3 music, and it can also display the MPEG1, MPEG2 and MPEG4 image files. As a result, the presence of portable media player means that the MP4 era arrives. The major difference between the portable media player and the MP3 music player is that the portable media player is able to access and play the pictures and films and to read the e-books. In addition, most portable media players are equipped with superior LCD monitors to provide the pictures and films with extremely good quality.

However, the portable media player is developed toward the goal of having powerful functionality and being lightweight, thin, short and small. Therefore, the sizes of the LCD monitors of the portable media players are mostly lesser than 3.5 inches so as to obtain the small sizes. But, the sizes of the LCD monitors are so small that it is strenuous for the user to watch the films, causing the occurrence of asthenopia. Although some portable media players are equipped with large-sized LCD monitors (about 7 inches), their sizes are also increased. Accordingly, they do not meet the current requirements of providing lightweight, thin, short and small portable media players so their have limited consumers.

Accordingly, there is a need to overcome the drawbacks of the conventional portable media player and to disclose an improved portable media player that has the advantages of large screen, small size, easy use and convenient carriage.

### SUMMARY OF THE INVENTION

In view of the above-mentioned conventional drawbacks, a major object of the present invention is to provide a glasses-type media player that has the advantages of large screen, low power consumption, high privacy, long operable time, easy use and convenient carriage.

In order to achieve the above-mentioned and other objects, the present invention discloses a glasses-type media player for reading information stored in an external memory card. The glasses-type media player comprises a wearing body, a circuit control unit, a video/audio output unit and a power source.

The wearing body has a glasses frame and a glasses lens connected to the glasses frame.

The circuit control unit is coupled to the glasses frame, and comprises a video/audio processing circuit, a control interface and at least one memory card slot, wherein the video/audio processing circuit is electrically connected to the memory card slot and the control interface.

The video/audio output unit is coupled to the glasses frame. The video/audio output unit comprises a microdisplay device and an audio output device. The microdisplay device and the audio output device are electrically connected to the video/audio processing circuit.

The power source is coupled to the glasses frame, and electrically connected to the circuit control unit and the video/audio output unit for supplying the circuit control unit and the video/audio output unit with the required electric power.

### BRIEF DESCRIPTION OF THE DRAWINGS

These and other features, aspects and advantages of the present invention will become better understood with regard to the following description, appended claims, and accompanying drawings, wherein:

FIG. 1 is an elevational diagram showing a first preferred embodiment of the present invention;

FIG. 2 is an elevational diagram showing the first preferred embodiment of the present invention as viewed from another direction;

FIG. 3 is an elevational diagram showing the first preferred embodiment of the present invention and a memory card;

FIG. 4 is a plan view showing a second preferred embodiment of the present invention; and

FIG. 5 is a diagram showing a coupling frame pivotally coupled to a microdisplay device and a glasses lens and another form of audio output device in accordance with the present invention.

### DETAILED DESCRIPTION OF THE PREFERRED EMBODIMENT

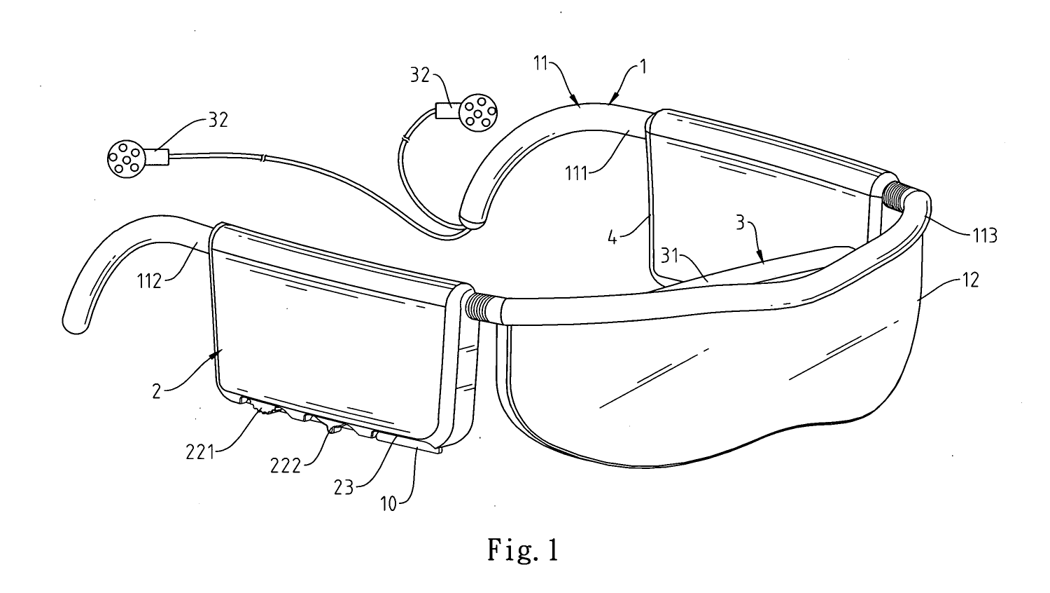

Referring to FIGS. 1 through 3, a first preferred embodiment of the present invention is shown. A glasses-type media player of the present invention is utilized for reading information stored in an external memory card 10. The glasses-type media player comprises a wearing body 1, a circuit control unit 2, a video/audio output unit 3 and a power source 4.

The wearing body 1 has a glasses frame 11 and a glasses lens 12 connected to the glasses frame 11. The glasses frame 11 has two glasses arms 111, 112 and a coupling frame 113 connected between these two glasses arms 111, 112. The coupling frame 113 is coupled to the glasses lens 12.

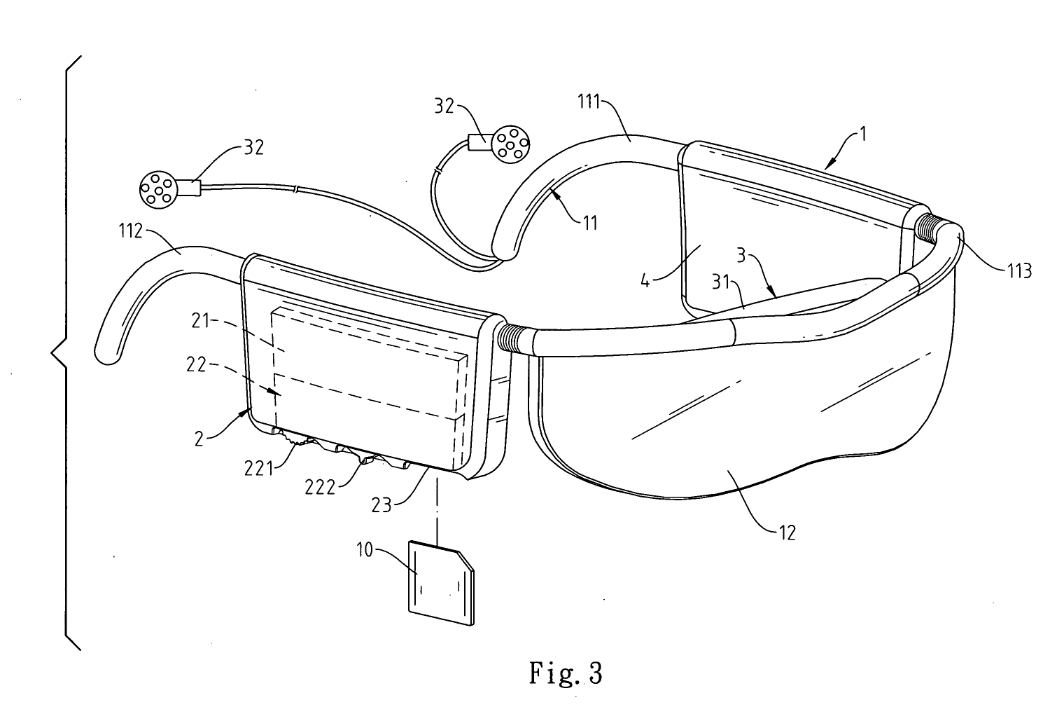

Referring again to FIG. 3, the above-mentioned circuit control unit 2 is coupled to one of these two glasses arms 111, 112. The circuit control unit 2 comprises a video/audio processing circuit 21, a control interface 22 and at least one memory card slot 23. The video/audio processing circuit 21 is able to operate and decode information of MPEG, JPEG and MJPEG formats. The video/audio processing circuit 21 is electrically connected to the memory card slot 23 and the control interface 22. The memory card slot 23 is suitable for insertion thereinto of the external memory card 10, which is a CF, SD, MS or XD memory card, to allow the video/audio processing circuit 21 to read the information. The control interface 22 is used for receiving a control command inputted by the user, and then transmitting this control command to the video/audio processing circuit 21. The control interface 22 is coupled to one of these two glasses arms 111, 112 of the glasses frame 11. In addition, the control interface 22 also has a volume adjusting device 221 and a jog dial 222 so that the user is enabled to key in the control command through the control interface 22 directly.

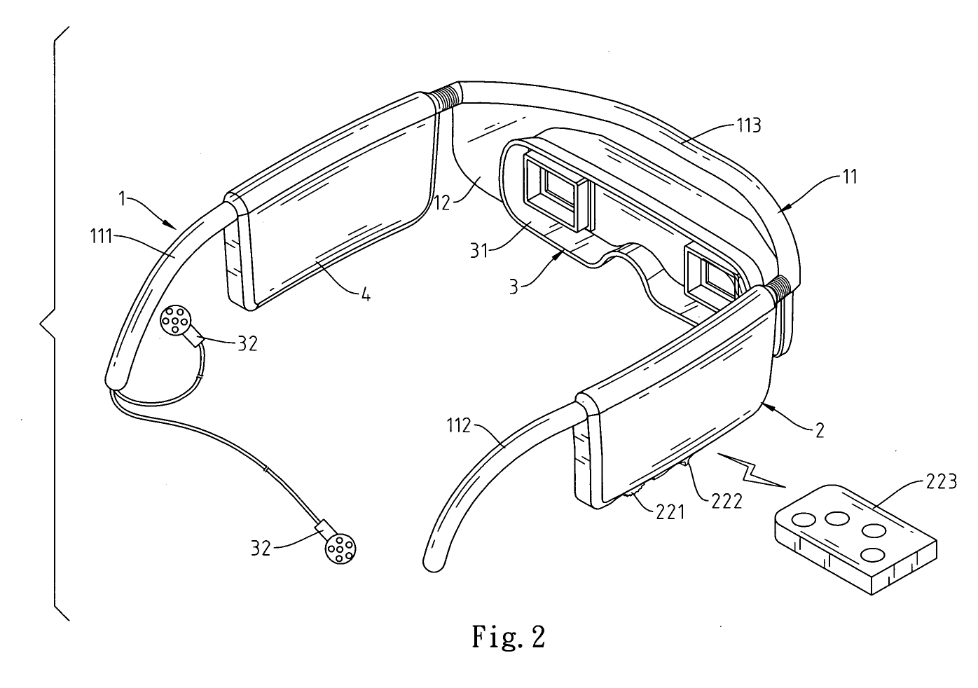

Referring to FIG. 2, the above-mentioned video/audio output unit 3 is coupled to the above-mentioned wearing body 1. The video/audio output unit 3 comprises a microdisplay device 31 and an audio output device 32. The microdisplay device 31 is electrically connected to the above-mentioned video/audio processing circuit 21, and coupled to the coupling frame 113. In addition, the microdisplay device 31 is also disposed on the inner lateral surface of the glasses lens 12 for showing the image information stored in the memory card 10. The audio output device 32 is electrically connected to the video/audio processing circuit 21, and extended outward from the rear ends of the glasses arms 111, 112 to output the audio information stored in the memory card 10.

Referring again to FIG. 2, the above-mentioned power source 4 is coupled to one of the glasses arms 111, 112, and electrically connected to the circuit control unit 2 and the video/audio output unit 3 for supplying the circuit control unit 2 and the video/audio output unit 3 with the required electric power.

Referring to FIG. 3, the utilization state of the above-mentioned components is shown. During the utilization, the memory card 10 is inserted into the memory card slot 23 to allow the video/audio processing circuit 21 to read the information stored in the memory card 10 and to operate and decode the information. In addition, the information stored in the memory card 10 can be displayed by the microdisplay device 31 and the audio output device 32. In addition, the display process can be controlled by the control interface 22.

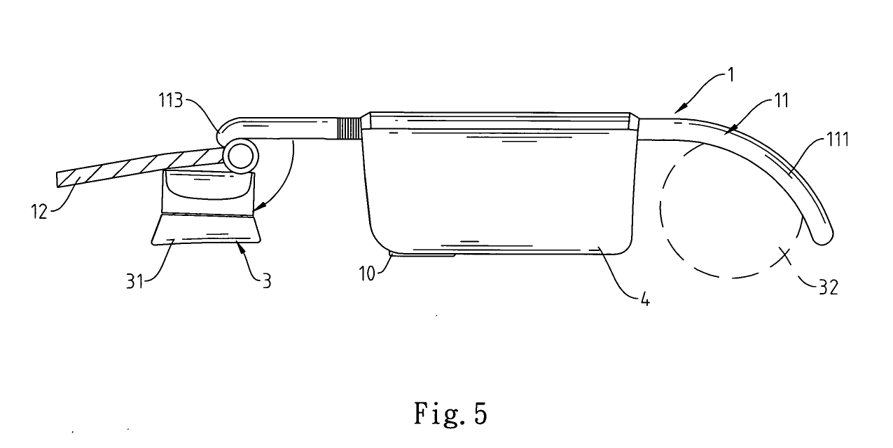

Moreover, the coupling frame 113 of the first preferred embodiment is coupled to the microdisplay device 31 and the glasses lens 12. Certainly, as shown in FIG. 5, the coupling frame 113 is pivotally coupled to the microdisplay device 31 and the glasses lens 12 in such a manner that the microdisplay device 31 and the glasses lens 12 are outward and upward rotatable. Accordingly, when the user's mobile phone is ringing or the user is being called by other people, the microdisplay device 31 and the glasses lens 12 need only be rotated outward and upward. There is no need to take off the glasses-type media player so it is more convenient to apply and use.

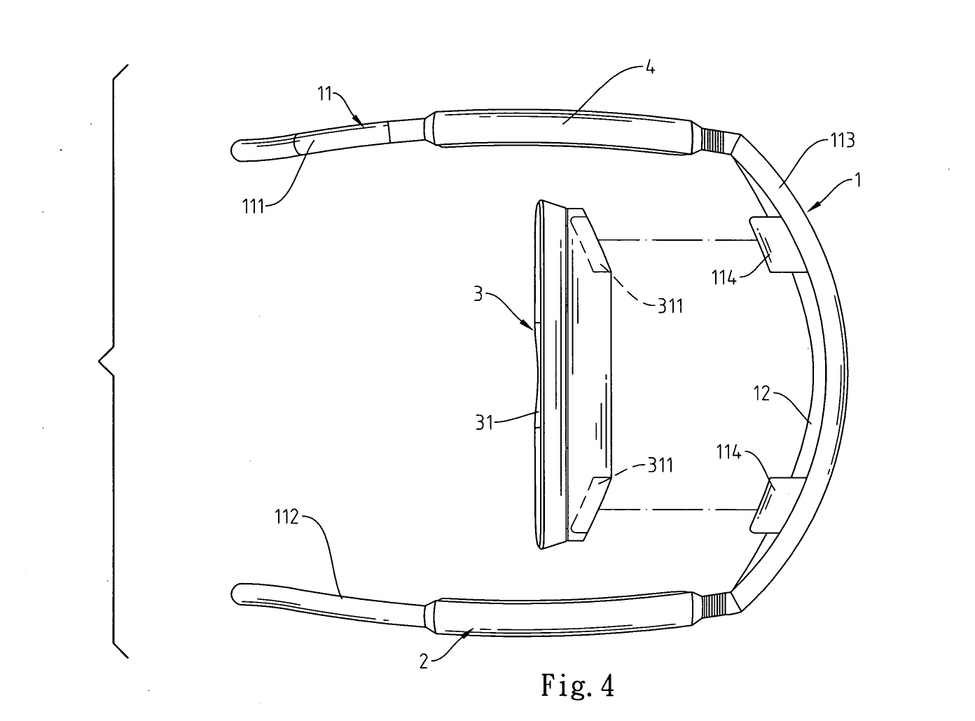

Referring to FIG. 4, a glasses-type media player of a second preferred embodiment is approximately identical to that of the first preferred embodiment. The differences between them consist in that the coupling frame 113 of the glasses frame 11 has at least one coupling pin 114 projected therefrom and the microdisplay device 31 has at least one positioning recess 311 formed thereon. Therefore, the microdisplay device 31 can be coupled to the glasses frame 11 by coupling the coupling pin 114 to the positioning recess 311. On the contrary, the coupling pin 114 can be detached from the positioning recess 311 to separate the microdisplay device 31 from the glasses frame 11. In other words, the microdisplay device 31 is detachable.

In addition, it is worthy to mention that the audio output device 32 can be an insert earphone (shown in FIG. 1) or a half-covering or full-covering earphone (shown in FIG. 5) to meet various requirements of different users.

Moreover, the glasses lens 12 of the wearing body 1 is for providing the shielding and beautifying effects so it is available in different forms to provide the required appearance. In addition, the glasses lens 12 may be replaced by other shelter, which provides the same purposes and effects as the above-mentioned preferred embodiments, and hence redundant description thereof is omitted.

Furthermore, the above-mentioned control interface 22 generally has the volume adjusting device 221 and the jog dial 222. Referring to FIG. 2, the control interface 22 can also wirelessly receive a control signal sent by a remote control 223, wherein the control signal is sent in accordance with an infrared communication standard or a Bluetooth communication standard, but is not limited hereto.

What the invention claimed is:

1. A glasses-type media player for reading information of an external memory card, comprising:
a wearing body having a glasses frame and a glasses lens connected to said glasses frame;
a circuit control unit coupled to said glasses frame, and comprising a control interface, at least one memory card slot and a video/audio processing circuit electrically connected to said memory card slot and said control interface;
a video/audio output unit coupled to said glasses frame, and comprising a microdisplay device and an audio output device, which are electrically connected to said video/audio processing circuit; and
a power source coupled to said glasses frame, and electrically connected to said circuit control unit and said video/audio output unit for supplying said circuit control unit and said video/audio output unit with the required electric power.

2. A glasses-type media player according to claim 1, wherein said glasses frame has two glasses arms and a coupling frame connected between said two glasses arms.

3. A glasses-type media player according to claim 2, wherein said coupling frame is pivotally connected to said microdisplay device and said glasses lens.

4. A glasses-type media player according to claim 2, wherein said coupling frame has at least one coupling pin projected therefrom and said microdisplay device has at least one positioning recess corresponding to said coupling pin.

5. A glasses-type media player according to claim 1, wherein said video/audio processing circuit is to operate and decode information of MPEG, JPEG and MJPEG formats.

6. A glasses-type media player according to claim 1, wherein said external memory card is a CF, SD, MS or XD memory card suitable for insertion into said memory card slot.

7. A glasses-type media player according to claim 1, wherein said control interface comprises a jog dial.

8. A glasses-type media player according to claim 1, wherein said control interface comprises a volume adjusting device.

9. A glasses-type media player according to claim 1, wherein said control interface comprises a remote control and said control interface is for receiving a control signal sent by said remote control.
